(19) United States
(12) Patent Application Publication
(10) Pub. No.: US 2014/0190099 A1
(43) Pub. Date: Jul. 10, 2014

(54) SILL PAN MEMBRANE

(71) Applicant: Protecto Wrap Company, Denver, CO (US)

(72) Inventor: John R. Hopkins, II, Bow Mar, CO (US)

(73) Assignee: Protecto Wrap Company, Denver, CO (US)

(21) Appl. No.: 14/137,333

(22) Filed: Dec. 20, 2013

Related U.S. Application Data
(60) Provisional application No. 61/740,689, filed on Dec. 21, 2012.

(51) Int. Cl. E06B 7/16; E06B 1/70

(52) U.S. Cl. CPC E06B 7/16; E06B 1/702
USPC 52/204.5; 52/741.4

(57) ABSTRACT

Disclosed herein are various waterproof membranes that may be applied to a sill surface of an opening in a building structure to waterproof that surface as well as direct water that penetrates through the opening out of the structure. Generally, a flexible waterproof membrane is adhesively applied to the sill surface for purposes of waterproofing that surface. In one arrangement, the membrane includes a conformable adhesive flap that extends beyond the front edge of the sill surface and which is flexible to allow stretching and adhering the flap to a surface that is transverse (e.g., vertical) to the remainder of the membrane. The membrane also includes a non-adhesive flap that may be disposed over the adhesive flap once it is adhered in a desired orientation. The non-adhesive flap provides a durable surface for the adhesive flap once it is stretched and adhered in place.

### CROSS REFERENCE

The present application claims the benefit of the filing date of U.S. Provisional Application No. 61/740,689 having a filing date of Dec. 21, 2012, the entire contents of which is incorporated herein by reference.

### FIELD OF THE INVENTION

The present invention generally relates to building products and, more particularly, pertains to an impermeable membrane that having a first portion that is adapted for application to a sill surface and a second portion that is conformable to a transverse surface for adherence thereto.

### BACKGROUND

One of the most common failure points for unwanted air and/or moisture in a building envelope is around doors and windows. Controlling air and/or moisture penetration is a serious concern, which may result in interior damage if not prevented or corrected in a timely manner. In addition, heat losses caused by air leakage around building openings have taken on new significance due to today's high-energy costs. Sealing such openings has typically been accomplished by caulking or using putty-like compound around openings between door and window frames to seal the gaps and prevent inward seepage of air and/or water into the building. However, over several years, such caulking typically cracks, as it cannot withstand the repeated expansion and contraction of the window. Some studies indicate that after several years in operation, a majority of all windows will leak through the window flange or the window itself. The same is often true for doors. This water leakage can lead to structural damage such as rotting of sill surfaces and mold.

Given these problems, there remains a need for an improved method for waterproofing internal components of an opening of a structure and/or for removing moisture that penetrates into the opening.

### SUMMARY

In view of the difficulties in waterproofing openings into building structures, such as door and window openings, provided herein are systems and methods (i.e., utilities) for use in waterproofing sill surfaces of such openings and/or removing water that penetrates into such an opening. Generally, the utilities discussed herein utilize one or more flexible membranes that are applied to the sill surface for purposes of waterproofing that surface. Such membranes may incorporate an adhesive material layer for adhering a first portion of the membrane to the sill surface and a second portion of the membrane to an outside surface of a building structure. In one aspect, a membrane is provided that provides a durable surface portion for disposition on a sill surface of an opening within a structure while providing a highly conformable portion for connection to a transverse outside surface of the opening. In this regard, a first portion of the membrane may be adhered to a first surface (e.g., a generally horizontal surface) and the second portion may be adhered to a second surface (e.g., a generally vertical surface). Thus, the membrane may seal an interface between these surfaces. It may be desirable that the portion of the membrane that is disposed on the horizontal surface (e.g., sill surface) provide a durable exposed surface. This may allow, for example, inserting shims between a window/door and the membrane without puncturing the membrane. That is, as the horizontal surface may support a door or window, it may be beneficial to provide an exposed membrane surface that is resistant to puncture. To facilitate the adherence of the second portion of the membrane to the second transverse surface, it may be desirable for the second portion of the membrane to be highly conformable. In this regard, the highly conformable second portion of the membrane may fold and/or stretch over the interface between the surfaces to provide a sealed transition between the surfaces, which may facilitate the removal of moisture from the horizontal surface to outside of the structure. Further, such membranes may include wicking material on one or more surfaces to allow for directing water out of a building structure.

In a first arrangement, the membrane includes a flexible adhesive material layer having a top surface and a bottom surface wherein a non-adhesive facer material is attached or adhered to a first portion of the top surface. For instance, the non-adhesive facer material may be adhered part way across the width of the top surface and along the entirety of the length of the top surface. A second portion of the top surface of the membrane is initially free of the facer material and is covered by a release sheet. While a first portion of the facer material is adhered to the adhesive material layer, a second portion of the facer material is non-adhered to the adhesive material layer. This non-adhered portion of the facer material forms a flap that is sized to cover some or all of the second portion of the top surface covered by the release sheet. When the release sheet is removed from the top surface, this portion of the membrane is more pliable than the portion covered by the facer material. Accordingly, this pliable portion may be stretched and adhered to a surface. The non-adhered portion of the facer material may then cover and adhere to the top surface of the pliable portion of the membrane to prevent unintended adherence thereto and to provide a protective cover for this portion of the membrane after the bottom surface of the pliable portion of the membrane is adhered. All or a portion of a bottom surface of the membrane may be an adhesive surface that may be covered by one or more release sheets.

Generally, the portion of the membrane covered by the non-adhesive facer material may be disposed on a horizontal surface while the second portion of the membrane may extend beyond the sill surface. That is, the second portion may form a flap that may be conformed to an outside surface or an opening. In this regard, it may be desirable that the flap be highly flexible and/or elastic. To have such flexibility, it may be desirable, but not necessary, that at least the flap of the membrane contain little or no internal reinforcement. In such an arrangement, membranes formed of a bituminous material or a butyl rubber compound may be utilized. However, it will be appreciated that other materials that provide flexibility, adherence and/or waterproofing properties may be utilized.

According to another arrangement, a utility is provided for forming a sill pan on a sill surface in an opening of a building structure. The utility includes disposing a flexible membrane across the length of a generally horizontal sill surface. Such a sill surface is typically disposed between first and second upright members (e.g., studs). In addition to being disposed across the length of the sill surface, the flexible membrane may, but not necessarily, include a first end that extends at least partially up a first upright member and a second end that extends at least partially up the second upright member. A release sheet may be removed from a forward portion of the membrane extends beyond the sill surface (e.g., disposed towards the outside of the structure). This forward portion may then be folded transverse to the generally horizontal sill surface and/or around the corners where the uprights meet the sill member. A bootm surface of the forward portion may be adhered to an outside surface of the opening. Stated otherwise, the forward portion of the membrane forms a flap that extends over, for example, exterior sheathing between the first and second uprights. This flap covers the interface between the sill surface and the outside surface of the opening providing a continuous path for water on the sill to exit the building structure. A non-adhesive facer material adhered to a rearward portion of the membrane may then be folded over the forward portion of the membrane and adhered to its top surface.

Forming the sill pan may further entail removing a release sheet from at least a portion of the bottom surface of the flexible membrane to expose a bottom adhesive surface. This bottom adhesive surface may be contacted to at least a portion of the sill surface. Further, end portions of the bottom surface may be contacted to the first and second upright members. In such an arrangement, the flexible membrane may be adhered to the sill surface and upright members.

### BRIEF DESCRIPTION OF THE DRAWINGS

FIG. 1 is a perspective view of one embodiment of a conformable membrane.

FIG. 2 illustrates removal of release sheets from the membrane of FIG. 1.

FIG. 3A-3C are perspective views of the membrane of FIG. 1 being applied within a window opening.

### DETAILED DESCRIPTION

Reference will now be made to the accompanying drawings, which at least assist in illustrating the various pertinent features of the present invention. In this regard, the following description where a flexible membrane forms a sill pan in a window opening is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. The embodiments described herein are further intended to explain the best modes known of practicing the invention and to enable others skilled in the art to utilize the invention in such, or other embodiments and with various modifications required by the particular application(s) or use(s) of the present invention.

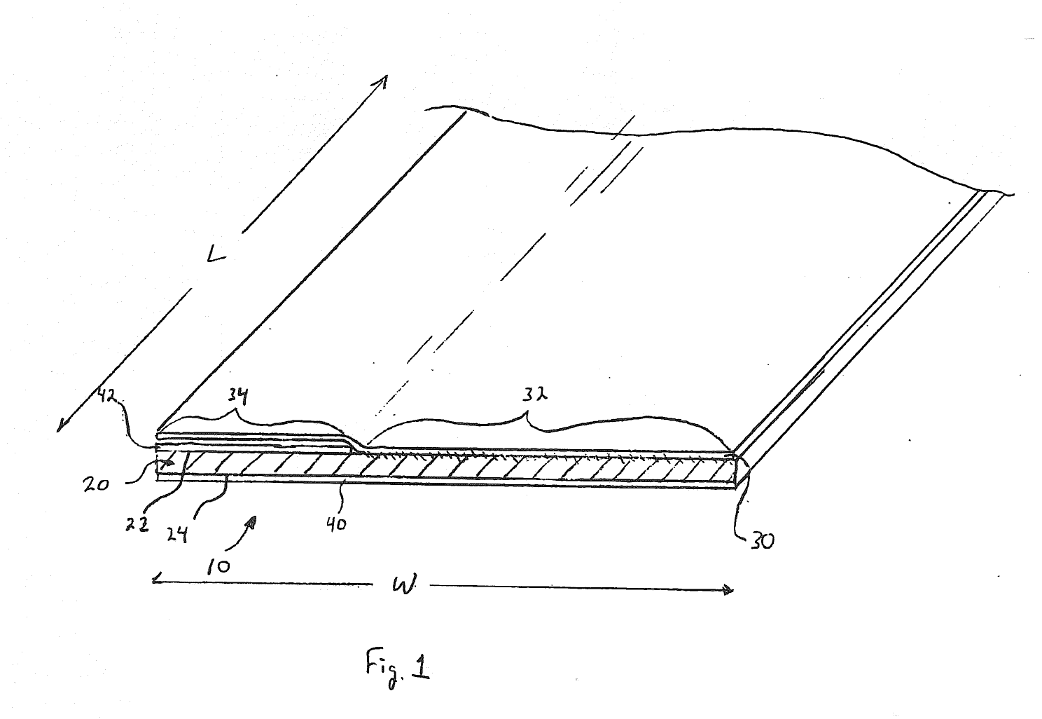

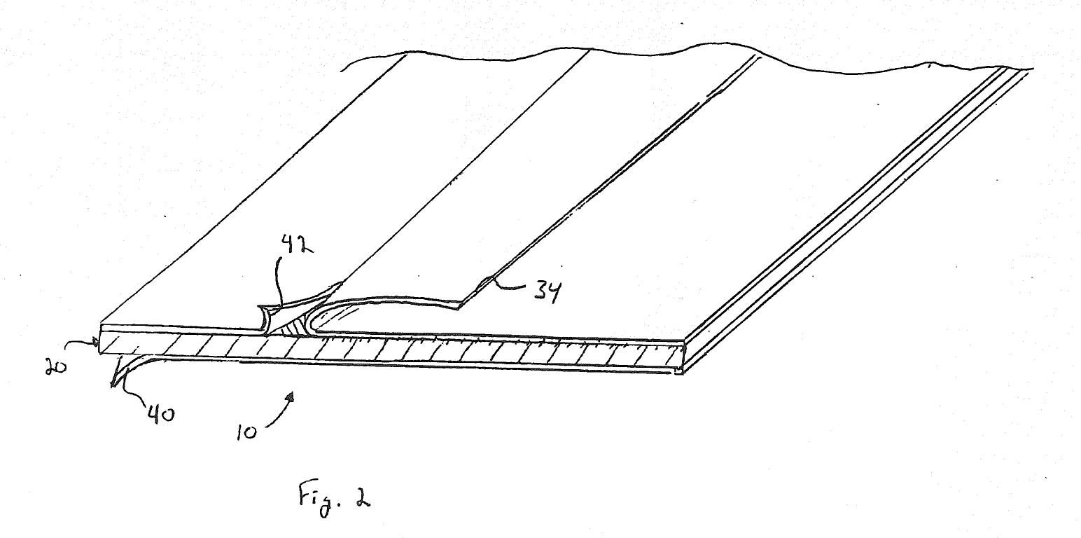

FIGS. 1 and 2 illustrate perspective views, of one embodiment of a composite membrane 10 in accordance with certain aspects of the present invention. Generally, the membrane 10 is adapted for adhesive interconnection to a sill surface such that it may provide waterproofing qualities to the sill surface. Stated otherwise, the membrane provides a substantially impermeable barrier to prevent moisture from contacting the sill surface. Generally, the membrane will have a length that is in excess of its width.

In the present embodiment, the membrane 10 is formed using an adhesive material layer 20 having first and second opposing surfaces. For purposes of the discussion, the opposing surfaces are referred to as the top surface 22 and bottom surface 24. A bottom release sheet 40 is releaseably attached to the bottom surface 24. A top release sheet 42 and a facer material 30 collectively cover the top surface 22. The construction of the adhesive sheet member of 20 may be varied. For instance, the adhesive material layer 20 may be formed from any flexible sheet-like material that provides the desired level of impermeability. For instance, the adhesive material layer 20 may be formed from a plastic sheet and have an adhesive applied to one or both of the top and bottom surfaces 22, 24. In an alternate arrangement, the adhesive material layer 20 may be formed of a material that provides both waterproofing properties (e.g., impermeability) as well as adhesive properties.

Non-limiting examples of suitable materials for use in producing an adhesive material layer having both adhesive and waterproofing properties include bitumen-containing materials such as various tar adhesives and rubberized asphalts, as well as natural and/or synthetic rubber (e.g., butyl-rubber) and butyl-rubber compounds. For instance, the adhesive material layer 20 may be at least partially constructed from a modified, rubberized asphalt material. In another arrangement, the adhesive sheet member may be formed from butyl rubber. Such material layers generally have a thickness between about 10 mils and about 60 mils. However, it will be appreciated that numerous other natural and synthetic materials may also be utilized to create an integrally formed adhesive sheet member having both adhesive and waterproof qualities. Additionally, the adhesive material layer 20 may itself be a multilayered structure. For instance, the adhesive material layer 20 may be constructed having one or more reinforcing layers (e.g., mesh layers), base sheet layers (e.g., plastic sheet layers) and/or various adhesive layers (e.g., bitumen-containing layers).

In order to attach the membrane 10 to a surface, the bottom surface 24 of the adhesive material layer 20 may be selectively exposed for adhesive attachment. In this regard, the bottom release sheet 40 is removably adhered to the bottom surface 24 of the membrane 10. Alternatively, first and second release sheets may be connected to separate portions across the width of the bottom surface 24 of the membrane 10. In any embodiment, the release sheet(s) 40 may be removed to expose the bottom surface 24 of the adhesive material layer, which may be contacted with (i.e., adhered to) a surface for which waterproofing is desired. Many different foils, films, papers or other sheet materials are suitable for use in constructing the release sheet 40. For example, the release sheet 40 may be formed from metals, plastics, or papers treated with silicon or other substances to provide a low level of adhesion to the underlying adhesive associated with the adhesive material layer 20. In any case, it is desirable that the release sheet 40 be easily removable from the adhesive sheet 20.

To enhance the durability of the membrane, the membrane 10 includes a facer material 30 that is permanently attached across a first portion 32 of the width of the top surface 22 of the membrane 10. The adhesive material layer 20 allows for conveniently interconnecting the facer material 30 to the top surface 22. In this regard, the facer material 30 may be formed in a sheet and may be applied to an exposed surface of the adhesive material layer 20 adhering the facer material to that surface. Such application may be performed utilizing compressive rollers in a manner similar to that disclosed in U.S. Pat. No. 6,676,779 entitled “Air and moisture barrier laminate apparatus” the entire contents of which are incorporated herein by reference. The facer material 30 may be any material that forms a durable non-adhesive surface. For instance, the facer material 30 may be formed from a sheet of plastic that is adhered to the top surface 22 of the sheet number 20. In such an arrangement, the thickness of the facer material will often be less than the thickness of the adhesive material layer. In one embodiment utilizing a plastic sheet facer material, the thickness of the facer is less than about 20 mils and in a further embodiment is less than about 10 mils.

In the present embodiment, the first portion 32 of the facer material 30 is non-removably adhered to the top surface 22 of the adhesive material layer 20 while a second portion 34 of the facer material 30 is not adhered to the adhesive material layer 20. This non-adhered second portion 34 of the facer material may be selectively disposed over and/or adhered to an exposed surface of the adhesive material layer 20 as discussed herein. In the embodiment illustrated in FIG. 1, the facer material 30 covers a first portion (e.g., rearward when applied to a sill surface) of the width of the top surface 22 of the adhesive material layer 20 and a top release sheet 42 releaseably covers a second portion (e.g., forward portion when applied to a sill surface) of the width of the top surface 22 of the adhesive sheet member 20. As shown, the non-adhered flap portion 34 of the facer material 30 is sized such that it may be disposed over the second portion of the adhesive material layer covered by the top release sheet 42. This allows covering the exposed adhesive top surface after removal of the top release sheet 42, as discussed herein.

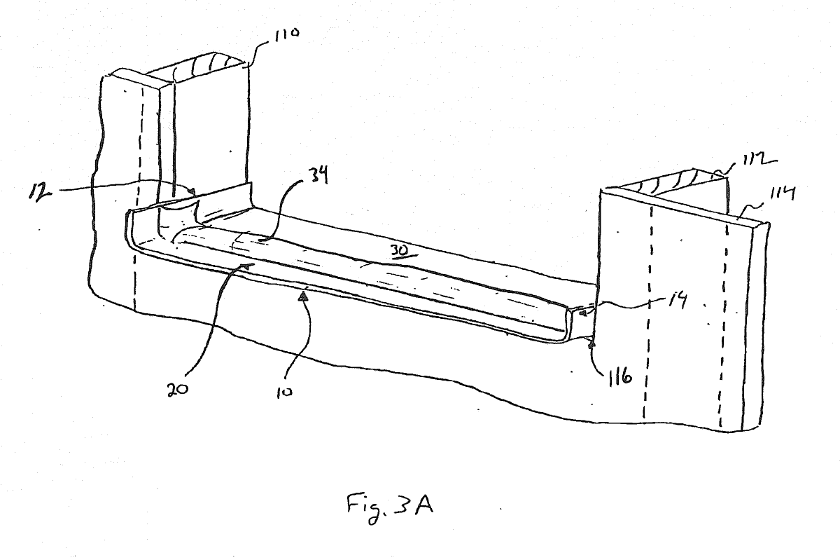

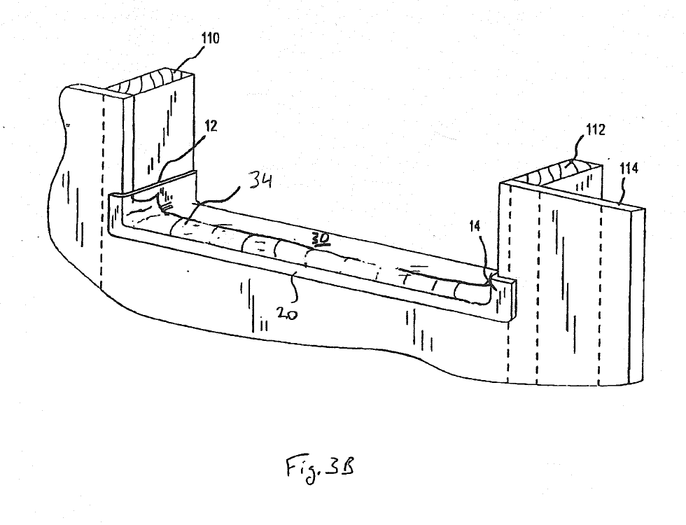

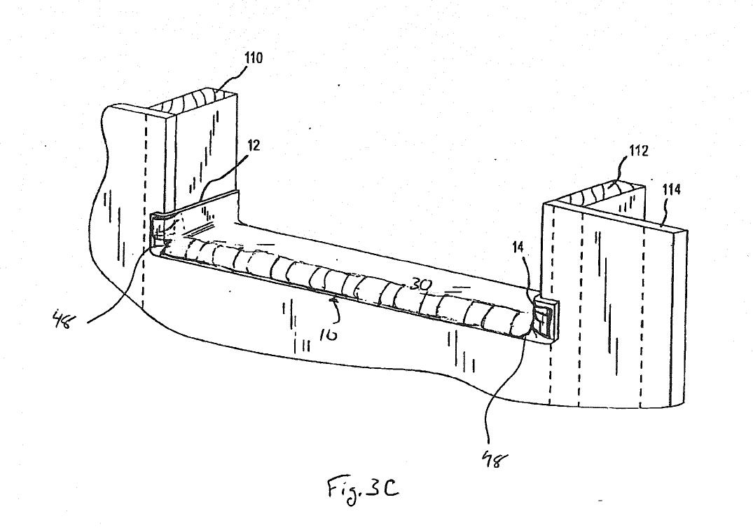

When utilized to create a window or door sill membrane or pan, the membrane 10 is formed as an elongated strip (e.g., a rectangular strip) having a length L that is typically longer than its width W. In such an arrangement, the rearward portion of the membrane covered by the facer material may be sized to cover a horizontal surface of a window sill. See FIG. 3A. For instance, the width of this rearward portion may be four or six inches based on the construction of the windowsill. This allows the forward portion of the membrane 10 to extend beyond the front lateral edge (e.g., outside edge) of the window sill for adherence to the outside surface (e.g., sheathing) of the window opening.

During application, the membrane may be cut to a desired length. Once appropriately sized, the bottom surface of the membrane 10 may be adhered to the sill surface of a window opening. See FIG. 3A. In this regard, the bottom release sheet(s) 40 may be removed from the bottom surface 24 of the adhesive material layer 20. (Not shown) An installer then adhesively secures the membrane 10 across the length of the windowsill. In the present embodiment, first and second ends 12, 14 of the membrane 10 are adhered partially up first and second upright members or studs 110, 112. Preferably, the width of the membrane 10 is such that its rearward portion covered by the facer material 30 is disposed on the horizontal sill surface while the forward portion 28 is covered by the top release sheet 42 and is initially free of the facer material. That is, the forward portion extends beyond the front lateral edge of the window sill.

The installer then may then fold the flap portion 34 of the facer material toward the rearward edge of the windowsill to expose the top release sheet 42. The top release sheet 42 may then be removed from the forward portion of the adhesive material layer 20 to provide a pliable adhesive material flap for adherence to the outside surface (i.e., sheathing) of the structure. That is, the installer folds the portion of the membrane that extends beyond the lateral edge of the windowsill and sheathing material 114 downwardly and adhesively secures this portion to the front surface of the sheathing material 114 as seen in FIG. 3B. It should be appreciated that the elasticity of this forward portion of the adhesive material layer 20, which is free of the facer material and preferably free of internal reinforcing materials, readily allows an installer to conform this section of the vertical surface of the sheathing below the window sill. More importantly, this allows for sealing the corners 116 of the window opening. That is, the elasticity of the adhesive material layer allows it to be stretched around the corners formed at the interfaces between the upright members/studs and the sill surface. Absent this elasticity, the membrane would require an incision at the corner which may allow water and/or wind infiltration into the structure. That is, if the membrane is cut to accommodate the adherence of the membrane around the corner 116, an opening exists into the structure. Wind may drive moisture/rain into such an opening. Generally, the elasticity of the adhesive material layer permits the material to stretch around the corners where the horizontal sill meets the uprights.

At this point, the membrane 10 is installed and the facer material 30 disposed on the top surface of the membrane 10 may extend from the back edge of the windowsill across the width of the windowsill to provide a durable surface for supporting a component such as a door or window and/or allowing shimming between the membrane (i.e., sill surface) and the door/window. Likewise, the forward portion of the membrane 10 may extend downwardly onto the outside surface of the sheathing material 114. As will be appreciated, this may allow directing water from within the envelope of a building to an outside surface of the building. The impermeability of the membrane 10 prevents water from contacting the generally wooden windowsill while the downwardly extending flap directs water outside of the structure. This combination may prevent structural damage of the windowsill and lessen the likelihood of mold forming within the walls of a completed structure.

However, the exposed adhesive surface 20 formed by removing the top release sheet can hinder the positioning a window or door on the sill. That is, if the top adhesive surface of the forward portion of the adhesive material layer 20 is left exposed, a window flange may become stuck to the membrane while being positioned in the window opening. Likewise the forward portion of the membrane has no durable coating. The membrane 10 of the present embodiment overcomes this shortcoming by using the non-adhered portion 34 of the facer material 30 to cover the exposed adhesive surface after the membrane 10 is installed on the window sill. See FIG. 3C. Specifically, the non-adhered portion of the facer material may, after the adhesive material layer is attached over the vertical front surface (e.g., sheathing) be laid over the adhesive surface exposed by removal of the top release sheet. In this regard, the non-adhered portion of the facer material may be adhered to the pliable portion of the membrane after it is stretched to a desired orientation and thereby cover the exposed adhesive material layer 20 on the front portion of the membrane. Accordingly, as the adhesive surface is covered, the problem of a door or window becoming adhered to the membrane in the incorrect locations is minimized or eliminated. As the facer material 30 is not as elastic as the adhesive material layer 20, it may be necessary to cut slits 48 into the facer material at the corners of the opening where the horizontal sill surface meets the vertical uprights. See FIG. 3C

In another embodiment, the membrane utilizes a wicking material layer as the facer material. The wicking material is adapted to move water from a first location on the membrane to a second location using capillary action. In this regard, the wicking material may be operative to move moisture out of a building envelope. The wicking material may be any material that is operative to effect the movement of moisture utilizing capillary action. Generally, textile materials having a fibrous structure provide the best capillary properties. In one embodiment, the wicking material is formed from an industrial felt. However, it will be appreciated that numerous other natural and synthetic materials may also be utilized. Use of the wicking material as a facer allows for removing water from the sill surface even if the sill surface is improperly sloped. That is, once the wicking material is adhered to the adhesive material layer on the outside surface of the building, a portion of the wicking material is disposed below the wicking material on the generally horizontal window sill and capillary action will draw water across the sill. Further, the wicking material may be operative draw water over the sill even when the windowsill is not perfectly level. That is, the capillary action of the wicking material may allow for wicking moisture up and over the front edge of a windowsill and to the outside surface of the building/structure.

While the invention has been described with reference to a preferred embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

1. An membrane for use in waterproofing a windowsill surface, comprising:
an adhesive material layer having a top surface and a bottom surface;
a bottom release sheet releaseably attached to the bottom surface of the adhesive material layer;
a top release sheet releaseably attached across a first portion of a width of the top surface of the adhesive material layer;
a facer layer adhered across a second portion of the width of the top surface of said adhesive material layer, the facer layer further including a non-adhered portion sized to extend over at least part of said top release sheet.

2. The membrane of claim 1, wherein said non-adhered flap portion is sized to extend over the entirety of said top release sheet.

3. The membrane of claim 1, wherein the adhesive material layer is waterproof.

4. The membrane of claim 3, wherein the adhesive material layer comprises a bitumen containing material.

5. The membrane of claim 3, wherein the adhesive material layer comprises a rubberized material.

6. The membrane of claim 3, wherein said adhesive material layer is between 10 mils and 40 mils thick.

7. The membrane of claim 1, wherein the facer layer comprises a polymeric sheet material.

8. The membrane of claim 1, wherein the facer layer has a thickness of less than 10 mils.

9. The membrane of claim 1, wherein the adhesive material layer is free of internal reinforcement.

10. The membrane of claim 1, wherein the bottom release sheet further comprises:
first and second bottom release sheets releaseably attached to first and second portions, respectively, of a width of the bottom surface of the adhesive material layer.

11. The membrane of claim 1, wherein said facer layer comprises a textile material operative to move moisture via capillary action.

12. A method for forming a sill seal on a sill surface of an opening in building structure using a flexible membrane, comprising:
removing a bottom release sheet from a bottom surface of an adhesive material layer of a membrane;
adhering said adhesive material layer along a length of a generally horizontal sill surface disposed between first and second upright members, wherein a front portion of the adhesive material layer extends beyond a lateral edge of said horizontal sill surface;
removing a top release sheet from a top surface of the front portion of the adhesive material layer;
conforming the front portion of the adhesive material to a horizontal surface extending between the first and second upright members, wherein at least a portion of the horizontal surface is below the sill surface; and
covering at least part of the top surface of the front portion of the adhesive material layer with a flap portion of a sheet member having a rearward portion that is adhered to a rearward portion of the top surface the adhesive material layer of the membrane.

13. The method of claim 12, wherein disposing includes adhering a first end of the adhesive material layer at least partially up the first upright member.

14. The method of claim 12, wherein conforming comprises:
adhering the front portion of the membrane around a corner defined by said horizontal sill surface and said first upright member.

15. The method of claim 14, further comprising:
stretching the front portion of the membrane around the corner defined by the horizontal sill surface and said first upright member.

16. The method of claim 13, further comprising:
contacting the adhesive bottom surface of the first portion of the flexible membrane to the generally horizontal sill surface.

17. The method of claim 16, further comprising:
contacting the adhesive bottom surface of the second portion of the flexible membrane to the outside surface of the opening.

18. The method claim 16, further comprising:
removing a top release sheet from a top surface of the front portion of the membrane.
